(19) United States
(12) Patent Application Publication
(10) Pub. No.: US 2008/0318031 A1
(43) Pub. Date: Dec. 25, 2008

(54) COOLING MATERIAL

(75) Inventor: Geoffrey Burton Smith, Epping (AU)

Correspondence Address: GANZ LAW, P.C., P O BOX 2200, HILLSBORO, OR, 97123, US

(73) Assignee: UNIVERSITY OF TECHNOLOGY, SYDNEY, Ultimo (AU)

(21) Appl. No.: 11/765,217

(22) Filed: Jun. 19, 2007

(51) Int. Cl. B32B 5/00

(52) U.S. Cl. 428/333; 428/338

(57) ABSTRACT

The present invention provides a cooling material which comprises particles that are arranged for generation of surface plasmon resonances. The surface plasmon resonances have a wavelength or wavelength range within an atmospheric window wavelength range in which the atmosphere of the earth has a greatly reduced average absorption and emission compared with the average absorption and emission in an adjacent wavelength range, whereby the cooling material is arranged for emission of thermal radiation associated with the generated surface plasmon resonances and absorption of radiation from the atmosphere is greatly reduced.

### BACKGROUND

The present invention broadly relates to a cooling material.

Various methods are used to cool interior spaces of buildings, refrigerate food, condense water or reduce the temperature of objects. These methods have in common that they require relatively large amounts of energy, which typically is provided in the form of electrical energy. For example, in countries which have a relatively warm climate the electrical energy required for cooling often exceeds the available electrical energy, which may result in a breakdown of a power grid. Further, electrical energy is at this time still at least partially generated using non-renewable energy resources, for example by burning coal, which is of concern for the environment and contributes to global warming. Consequently, it would be advantageous if cooling could be achieved in a manner that uses less energy. There is a need for technological advancement.

### SUMMARY

In one possible embodiment, the inventive subject matter contemplates a cooling material which comprises particles that are arranged for generation of surface plasmon resonances having a wavelength or wavelength range within an atmospheric window wavelength range in which the atmosphere of the earth has a greatly reduced average absorption and emission compared with the average absorption and emission in an adjacent wavelength range, whereby the cooling material is arranged for emission of thermal radiation associated with the generated surface plasmon resonances and absorption of radiation from the atmosphere is greatly reduced.

Throughout this specification the term “surface plasmon” is used for a surface plasmon excitation that involves ionic motion, such as that often referred to as “Fröhlich resonance”.

Because the atmosphere of the earth has very low absorption within the atmospheric window wavelength range, only a very small amount of radiation is returned from the atmosphere to the particles within that wavelength range and emitted radiation is largely directed through the atmosphere and into space where the typical temperature is of the order of 4 Kelvin.

The energy associated with the emitted radiation is at least partially, typically mainly, drawn from thermal energy of the cooling material or a medium that is in thermal contact with the cooling material and the thermal energy is emitted by “pumped” away from the cooling material. As a consequence, cooling of the cooling material and the medium that may be in thermal contact with the cooling material is possible without the need for electrical energy and at low cost. Further, during the night, or when irradiation by the sun is avoided, cooling well below ambient temperature is possible.

In embodiments of the present invention the cooling material is arranged to enable cooling to temperatures that are 5°, 10°, 20° below an ambient temperature or even lower.

The atmospheric window wavelength range typically includes a minimum of the average absorption of the atmosphere of the earth. The atmosphere has atmospheric windows within the wavelength ranges of 3 to 5 μm and 7.9 μm to 13 μm. Within these wavelength ranges the emission of the sun is also negligible and often regarded as zero, which has the added advantage that even during daytime the cooling material only absorbs very little radiation from the sun within that wavelength range.

The particles typically are arranged so that at least some, typically the majority or all, of the resonant surface plasmons have a wavelength within the wavelength range from 1-7 μm, 2-6 μm, 3-5 μm, and/or any one of 5-16 μm, 7-14 μm, 8-13 μm and 7.9-13 μm.

However, it is to be appreciated that alternatively the particles may be arranged so that surface plasmons are resonantly generated within a wavelength range that is at least partially within a wavelength range in which the atmosphere has a window. Further, the atmospheric window wavelength range may be one of a plurality of atmospheric window ranges, such as the wavelength range of 3-5 μm and 7.9 to 13 μm. The particles may also be arranged so that a portion of the emitted radiation is emitted within a wavelength range outside the atmospheric window wavelength range.

The cooling material typically is arranged to reflect at least some incident radiation, such as radiation from the atmosphere and/or from the sun in the daytime. For example, the cooling material may comprise a reflective layer positioned below the particles and may be arranged to reflect at least a portion of incident radiation. The reflective layer may for example be a metallic layer over which the particles are positioned. For example, the cooling material may be arranged so that the majority of incident radiation is reflected by the material. In this case the cooling material has the significant advantage of improved cooling efficiency as then the cooling material typically only has increased absorption within the atmospheric window energy range where the intensity of incident radiation is much reduced or negligible.

In another possible embodiment of the inventive subject matter the reflective material also reflects incident radiation having a wavelength within the atmospheric window wavelength range.

Alternatively or additionally the material may comprise one or more layers or foils that comprise a component material that is substantially transmissive for a wavelength range outside the atmospheric window wavelength range and may be positioned on a reflective material or may stand free. For example, the layer or foil may comprise a polymeric material in which the particles are embedded or adjacent to which the particles are positioned.

The wavelength of the resonant surface plasmon absorption depends on the composition, shape, relative orientation and size of the particles, which typically are nano-sized particles. By controlling the composition and/or shape and/or size and/or relative orientation of the particles, it is consequently possible to control the wavelength range of the resonant surface plasmon absorption.

For example, the particles may comprise SiC or another suitable material and typically have a size and/or shape that is selected so that the particles have resonant enhancement of surface plasmon absorption within the atmospheric window wavelength range. For example, the particles may be largely spherical or may be largely elliptical. They may have a diameter within the range of 10-100 nm, typically of the order of 50 nm or less. The cooling material may also comprise particles that have differing compositions and/or shapes and/or sizes and/or relative orientations so that the particles have more than one resonant surface plasmon wavelength or wavelength range within the atmospheric window wavelength range.

In another possible embodiment, the inventive subject matter contemplates a method of cooling a material, the cooling material comprising particles, the method comprising:
generating surface plasmons in the particles, the surface plasmons having a resonant enhancement at a wavelength or wavelength range within an atmospheric window wavelength range in which the atmosphere of the earth has low or negligible average absorption and emission compared with the average absorption and emission in an adjacent wavelength range; and
emitting at least a portion of the energy associated with the resonant surface plasmons from the particles in form of radiation having a wavelength within the atmospheric window wavelength range.

The atmospheric window wavelength range typically includes a minimum of the average absorption of the atmosphere of the earth.

The particles typically may be arranged so that at least some, typically the majority or all, resonant surface plasmons have a wavelength within the wavelength range from 1-7 μm, 2-6 μm, 3-5 μm, and/or any one of 5-16 μm, 7-14 μm, 8-13 μm and 7.9-13 μm.

The method typically also may comprise the step of reflecting radiation having a wavelength within and/or outside the atmospheric window wavelength range. These and other embodiments are described in more detail in the following detailed descriptions and the figures.

The foregoing is not intended to be an exhaustive list of embodiments and features of the present inventive subject matter. Persons skilled in the art are capable of appreciating other embodiments and features from the following detailed description in conjunction with the drawings.

### BRIEF DESCRIPTION OF THE DRAWINGS

FIG. 1 shows a transmission spectrum of the atmosphere of the earth as a function of wavelength,

FIG. 2 shows a cooling material according to an embodiment of the present invention, and

FIG. 3 shows a cooling material according to another embodiment of the present invention.

### DETAILED DESCRIPTION

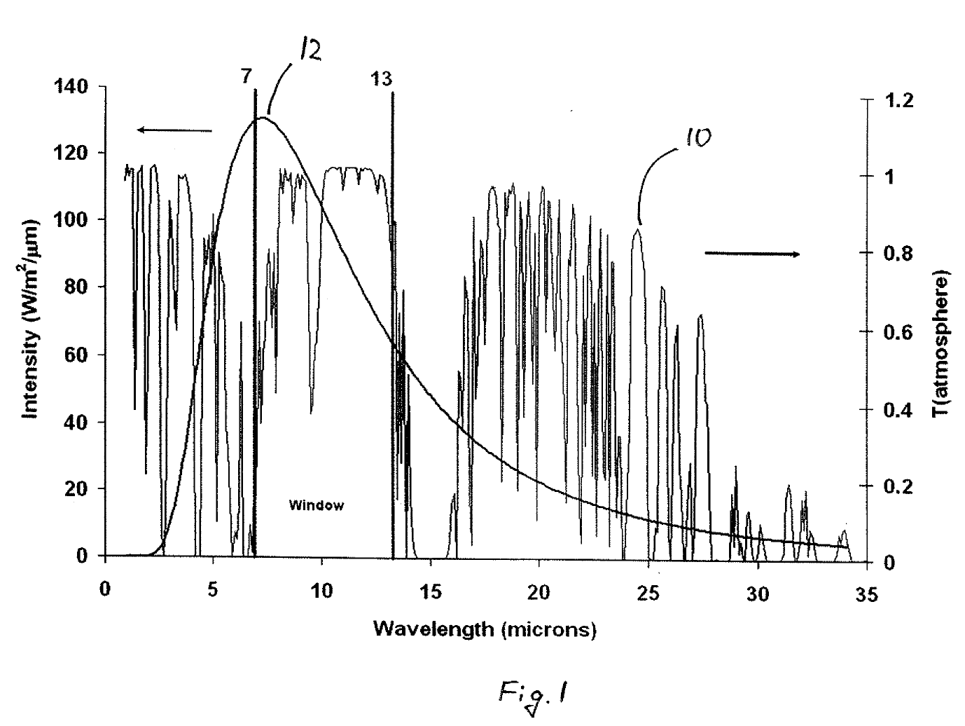

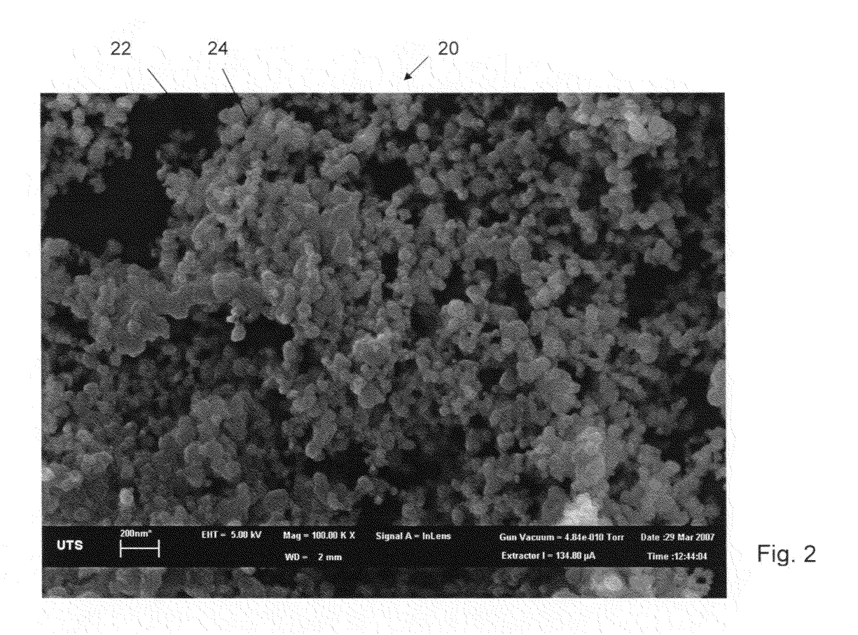

Referring initially to FIGS. 1 and 2, a cooling material and a method of cooling a material according to a specific embodiment of the present invention are now described.

FIG. 1 shows a transmission spectrum 10 of the atmosphere of the earth for substantially cloud free conditions. The average transmission is increased to nearly 1 within the range of approximately 7.9 to 13 μm compared to adjacent wavelength ranges. Further, the average transmission of the atmosphere is increased within a wavelength range of 3-5 μm. Within these wavelength ranges that atmosphere of the earth has “windows”. Plot 12 is an estimation of the emission spectrum of a black body having a temperature of 100° C., which was calculated using Wein's law and gives an example of the emission spectrum for a medium that may be cooled using the cooling material according to embodiments of the present invention.

FIG. 2 shows a secondary electron microscopy micrograph of a cooling material according to a specific embodiment of the present invention. The cooling material 20 comprises a reflective metallic layer 22, which in this embodiment is provided in the form of an aluminum layer positioned on a substrate. Further, the cooling material 20 comprises SiC particles which are positioned on the metallic layer 22. The SiC particles have an average diameter of approximately 50 nm and are deposited using suitable spin coating procedures.

The SiC particles 24 are in this embodiment nano-particles and the majority of the surface of the particles 24 is exposed to air. These particles 24 show resonantly enhanced absorption of radiation at a wavelength range of 10 to 13 μm. Within that wavelength range surface plasmons are generated. The wavelength range of resonant plasmon absorption is within the above-described atmospheric window wavelength range. For that wavelength range the average absorption of the atmosphere of the earth is very low and consequently very little radiation in this wavelength range is transferred from the atmosphere to the cooling material 20.

The energy associated with the emitted radiation is largely drawn from the thermal energy of the particles 24 and/or from a medium that is in thermal contact with the particles 24. Due to the atmospheric window, the emitted radiation is largely transmitted through the atmosphere and directed to space where the temperature typically is 4 Kelvin. Consequently, the cooling material 20 functions as a pump of thermal energy.

The reflective material 22 has the added advantage that a large portion of incident radiation is reflected away from the cooling material 20 and consequently thermal absorption of radiation having a wavelength within or outside the atmospheric window is reduced, which increases cooling efficiency.

The energy of the surface plasmons depends on the composition of particles, the size of the particles, the shape of the particles and their orientation relative to each other. By selecting properties of the particles it is possible to control the energy of the surface plasmons. For example, the particles 24 may be spherical, may have an elliptical shape or any other suitable shape. The particles 24 may also comprise particles of differing shape, size or composition so that the surface plasmon absorption wavelength is spread throughout at least a portion of the atmospheric window.

In variations of the above-described embodiment the particles 24 may be composed of other suitable materials that show surface plasmon resonances, such as BN and BeO. Further, the reflective material 22 may be composed of any other suitable reflective material.

The reflective material 22 improves the cooling efficiency. However, it is to be appreciated that the cooling material may not necessarily comprise a reflective material. Further, the particles 24 may be embedded in a transmissive material, such as a suitable polymeric material that is positioned upon the reflective material 22. For example, the polymeric material may comprise polyethylene or a fluorinated material.

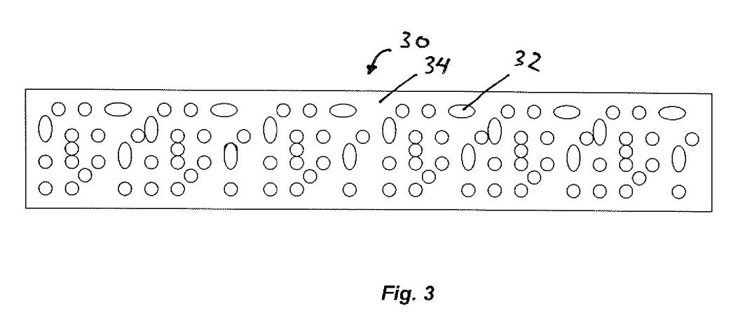

Referring now to FIG. 3, a cooling material according to another specific embodiment of the present invention is now described. In this embodiment the cooling material 30 comprises particles 32 which are comparable in shape and composition to particles 24 shown in FIG. 2 and described above. In this example, however, the particles 32 are positioned within a matrix of a polymeric material 34 that is largely transparent to everyday thermal radiation within a black body wavelength range, such as radiation having a wavelength within the range of 3-28 μm, or a wavelength range outside one or both of 3-5 and 7.9-13 μm, or most of solar spectral range in addition to the black body radiation range. For example, the polymeric material may comprise polyethylene or a fluorinated polymeric material.

In this embodiment the polymeric material 34 is selected so that incident radiation is largely transmitted. The absorption of thermal energy by the particles 32 involves generation of surface plasmons and radiation is emitted from the cooling material 30. In contrast to the cooling material 20, incident radiation is not reflected but largely transmitted through the cooling material 30, which also reduces thermal absorption of radiation directed to the cooling material 30 and thereby improves cooling efficiency.

Persons skilled in the art will recognize that many modifications and variations are possible in the details, materials, and arrangements of the parts and actions which have been described and illustrated in order to explain the nature of this inventive concept and that such modifications and variations do not depart from the spirit and scope of the teachings and claims contained therein.

Currently claimed inventions:

1. A cooling material which comprises particles that are arranged for generation of surface plasmon resonances having a wavelength or wavelength range within an atmospheric window wavelength range in which the atmosphere of the earth has a greatly reduced average absorption and emission compared with the average absorption and emission in an adjacent wavelength range, whereby the cooling material is arranged for emission of thermal radiation associated with the generated surface plasmon resonances and absorption of radiation originating from the atmosphere is greatly reduced.

2. The cooling material of claim 1 wherein the atmospheric window wavelength range includes a minimum of the average absorption of the atmosphere of the earth.

3. The cooling material of claim 1 wherein the particles are arranged so that at least some of the resonant surface plasmons have a wavelength within the wavelength range from 3-5 μm and/or 7.9-13 μm.

4. The cooling material of claim 1 wherein the particles are arranged so that the majority of the resonant surface plasmons have a wavelength within the wavelength range from 3-5 μm and/or 7.9-13 μm.

5. The cooling material of claim 1 wherein the cooling material is arranged to reflect at least some incident radiation.

6. The cooling material of claim 1 comprising a layer or foil that comprises a component material that is substantially transmissive for a wavelength range inside and outside the atmospheric window wavelength range.

7. The cooling material of claim 6 wherein the layer or foil comprises a polymeric material.

8. The cooling material of claim 7 wherein the particles are embedded in the polymeric material.

9. The cooling material of claim 7 wherein the particles are positioned adjacent the polymeric material.

10. The cooling material of claim 1 wherein the particles have a size that is selected so that the particles have resonant enhancement of surface plasmon absorption within the atmospheric window wavelength range.

11. The cooling material of claim 1 wherein the particles have a shape that is selected so that the particles have resonant enhancement of surface plasmon absorption within the atmospheric window wavelength range.

12. The cooling material of claim 1 wherein the particles have a diameter within the range of 10-100 nm.

13. The cooling material of claim 1 wherein the particles have a diameter of approximately 50 nm.

14. The cooling material of claim 1 wherein the particles have a diameter of less than 50 nm.

15. The cooling material of claim 1 wherein the particles comprise SiC.

16. A method of cooling a material, the cooling material comprising particles, the method comprising:
generating surface plasmons in the particles, the surface plasmons having a resonant enhancement at a wavelength or wavelength range within an atmospheric window wavelength range in which the atmosphere of the earth has low or negligible average absorption and emission compared with the average absorption and emission in an adjacent wavelength range; and
emitting at least a portion of the energy associated with the resonant surface plasmons from the particles in form of radiation having a wavelength within the atmospheric window wavelength range.

17. The method of claim 16 wherein the atmospheric window wavelength range includes a minimum of the average absorption of the atmosphere of the earth.

18. The cooling material of claim 16 wherein the particles are arranged so that at least some of the resonant surface plasmons have a wavelength within the wavelength range from 3-5 μm and/or 7.9-13 μm.

19. The cooling material of claim 16 wherein the particles are arranged so that the majority of the resonant surface plasmons have a wavelength within the wavelength range from 3-5 μm and/or 7.9-13 μm.

20. The method of claim 16 also comprising the step of reflecting radiation having a wavelength within and/or outside the atmospheric window wavelength range.
